(19) United States
(12) Patent Application Publication
(10) Pub. No.: US 2022/0027251 A1
(43) Pub. Date: Jan. 27, 2022

(54) SYSTEM FOR MONITORING ACTIVITY IN A PROCESS AND METHOD THEREOF

(71) Applicant: HCL TECHNOLOGIES LIMITED, New Delhi (IN)

(72) Inventors: Ian PHILIPS, London (GB); Richard KEMP, London (GB); Shakir LADAK, London (GB)

(73) Assignee: HCL TECHNOLOGIES LIMITED, New Delhi (IN)

(21) Appl. No.: 16/936,308

(22) Filed: Jul. 22, 2020

(51) Int. Cl. G06F 11/34; G06F 3/0484; G06F 3/0482

(52) U.S. Cl. CPC G06F 11/3438; G06F 3/0482; G06F 3/04847

(57) ABSTRACT

The present disclosure relates to system(s) and method(s) for monitoring each activity in a process. The method comprises capturing target data associated with a target type, corresponding to an activity in a process, selected by a user. The target type is at least one of a cut-off, an uptime, a count, a duration, a throughput, and a comparison. Further, the method comprises analysing the target data using threshold data and data stream in real time. Furthermore, the method comprises monitoring the activity in the process based on the analysis of the target type.

### CROSS-REFERENCE TO RELATED APPLICATIONS AND PRIORITY

The present application does not claim priority from any patent application.

### TECHNICAL FIELD

The present disclosure in general relates to the field of monitoring each activity. More particularly, the present invention relates to a system and method for monitoring each activity in a process.

### BACKGROUND

Every business process has a requirement to meet an outcome. For example, a financial organization will have a requirement to ensure payments are made in time. These outcomes will be called ‘targets’ and are sometimes referred to as SLA's. The business function will entail a business flow which will encompass a number of process flow steps that are required to achieve the business outcome, delivering the product to the customer, each flow step will have a number of interfaces. In order have clear transparency of the end to end flow and its status, it is important to ensure that a user understands the status of each process steps and interfaces. It is to be noted that each target needs a set of standard types which are observed and asserted in standard ways against the process steps and interfaces to get a status.

### SUMMARY

Before the present system and methods for monitoring each activity in a process, is described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for monitoring each activity in a process. This summary is not intended to identify essential features of the claimed subject matter nor is it intended for use in determining or limiting the scope of the claimed subject matter.

In one implementation, a method for monitoring each activity in a process. The method may comprise capturing target data associated with a target type, corresponding to an activity in a process, selected by a user. The target type may be at least one of a cut-off, an uptime, a count, a duration, a throughput, and a comparison. Further, the method may comprise analysing the target data using threshold data and data stream in real time. Furthermore, the method may comprise monitoring the activity in the process based on the analysis of the target type.

In another implementation, a system for monitoring each activity in a process is illustrated. The system comprises a user interface system for capturing target data associated with a target type, corresponding to an activity in a process, selected by a user. The target type may be at least one of a cut-off, an uptime, a count, a duration, a throughput, and a comparison. Further, the user interface system is further configured for analysing the target data using threshold data and data stream in real time. Furthermore, the user interface system is configured for monitoring the activity in the process based on the analysis of the target type.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates component details of the system for monitoring the activity in the process, in accordance with an embodiment of the present subject matter.

FIG. 2 illustrates deployment details of the system of FIG. 1, in accordance with an embodiment of the present subject matter.

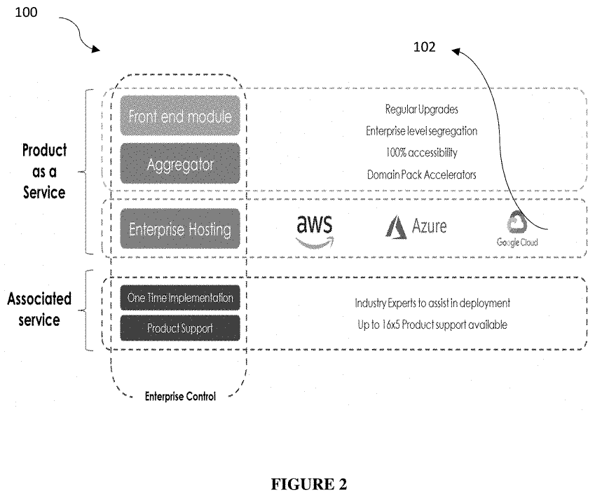

FIG. 3 illustrates an overview of target types associated with the activity in the process, in accordance with an embodiment of the present subject matter.

FIG. 4 illustrates an exemplary embodiment for monitoring the process using a cut-off as a target type, in accordance with an embodiment of the present subject matter.

FIG. 5 illustrates an exemplary embodiment for monitoring the process using an uptime as a target type, in accordance with an embodiment of the present subject matter.

FIG. 6 illustrates an exemplary embodiment for monitoring the process using a count as a target type, in accordance with an embodiment of the present subject matter.

FIG. 7 illustrates an exemplary embodiment for monitoring the process using a duration as a target type, in accordance with an embodiment of the present subject matter.

FIG. 8 illustrates an exemplary embodiment for monitoring the process using an uptime as a comparison, in accordance with an embodiment of the present subject matter.

FIG. 9 illustrates an exemplary embodiment for monitoring the process using a throughput as a target type, in accordance with an embodiment of the present subject matter.

FIG. 10 illustrates a method for monitoring an activity in a process, in accordance with an embodiment of the present subject matter.

### DETAILED DESCRIPTION

Some embodiments of the present disclosure, illustrating all its features, will now be discussed in detail. The words “including”, “comprising”, “consisting”, “containing”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods for monitoring an activity in a process are now described. The disclosed embodiments of the system and method for monitoring the activity in the process are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for monitoring an activity in a process is not intended to be limited to the embodiments illustrated, but is to be accorded the widest scope consistent with the principles and features described herein.

In one embodiment, a method for monitoring an activity in a process is disclosed. In the embodiment, target data associated with a target type corresponding to an activity in a process may be captured. The target data may be further analysed based on threshold data and data stream in real time. Based on the analysis, the activity in the process may be monitored.

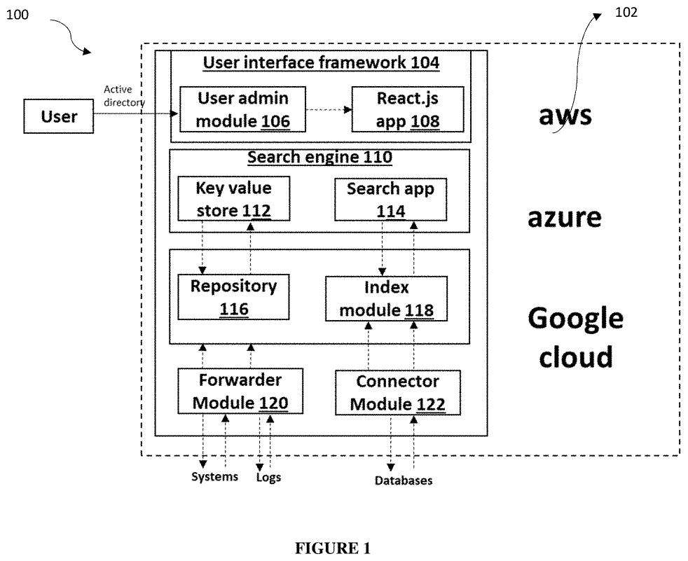

In an embodiment FIG. 1, discloses details about the system 100 for monitoring an activity, in an exemplary embodiment. The system 102 may be referred as an iControl product. The system 100 comprises a platform providing monitoring of process flow having targets defined within. Data required for monitoring may be provided through the monitoring tools. The system 100 may also be integrated with external system(s) for sharing data required for monitoring the activity associated with the process flow.

The system 102 also comprises plurality of modules (discussed later). The modules may include routines, programs, objects, components, data structures, and the like, which perform particular tasks, functions or implement particular abstract data types.

The system 100 may be deployed as a software over one or more web services such as cloud computing services 102. The web services 102 comprise one of a google cloud computing service, amazon web service (aws) or azure cloud computing service. User interface system 104 provides the UI. The UI comprises underlying user admin module 106 and react.js app 108 for building the user interface. The user interacts with the system 100 through the user interface system 104. The react.js app 108 is a Javascript component and is configured to setup flows, metrics, widgets and run reports.

In one implementation, the user may access the system 100 via the I/O interface. The user may be registered using the I/O interface in order to use the system 100. In one aspect, the user may access the I/O interface of the system 100 for obtaining information, providing input information or configuring the system 100.

The system 100 further comprises a search engine 110 configured to provide search management by receiving one or more search requests form the user. The search engine 110 also reports results for the search request to the user. The search engine 110 is having a key value store 112 and a search app 114. The KV store 112 data as key-value pairs in collections (or as database tables). The KV store 112 maintains entry of each of the data helps in searching for data towards the search request.

The search app 114 stores rules engine and backend functionality comprising each of a calculation of target performance, storing of base data, and responding to client requests.

The key value (KV) store 112 is communicatively coupled to a repository 116 and the search app 114 is communicatively coupled to an index module 118.

The repository 116 is accessed by the search engine 110 for retrieving results for the search requests form the user. The index module 118 is configured to define indexes, for example, target as an index and observations as an index.

The data stored in the repository 116, amongst other things, also serve as a repository for storing data processed, received, and generated by one or more of the modules configured in the system (detailed below). The data may include data generated as a result of the execution of one or more modules.

The repository 116 is further communicatively coupled to a forwarder module 120 and the index module is communicatively coupled to a connector module 122. The forwarder module 120 is provided to connect the system 100 with machines for pushing data into the system 100. The connector module 122 acts as interface for loading data from disparate technologies onto the system 100.

The forwarder module 120 communicates with systems and logs and the connector module 122 communicates with external databases.

In one implementation, plurality of modules (not shown in Figure) may include a capturing module, an analysing module, a monitoring module, and other modules. The other modules may include programs or coded instructions that supplement applications and functions of the system 100.

In one embodiment, the capturing module may capture target data associated with a target types corresponding to an activity from a set of activities. The set of activities may be associated with a process. The process may be further referred as a business process. The target type may be one of a cut-off, an uptime, a count, a duration, a throughput, and a comparison. The target data may comprise the target type, a target owner, a target description, a target status, a target impact and the like.

The target data may be captured for a predefined time. The predefined time may comprise a start time and an end time. The Predefined time may be defined by a user as per a user's requirement. In one aspect, the target data associated with the target type may be used to monitor end to end activity of the process.

In an embodiment, deployment details of the system 100 are shown. The system 100 may be deployed as a product as a service. The system may be configured to ensure each of a regular updates through front end module, enterprise level segregation of services through aggregator, 100% accessibility of services and the system may be provided with domain pack accelerators.

The system is configured with web services 102 for supporting the enterprise hosting. Associated services within the system 100 provides system to be just configured through a one time implementation with product support. The system 100 is configured to provide a complete enterprise control.

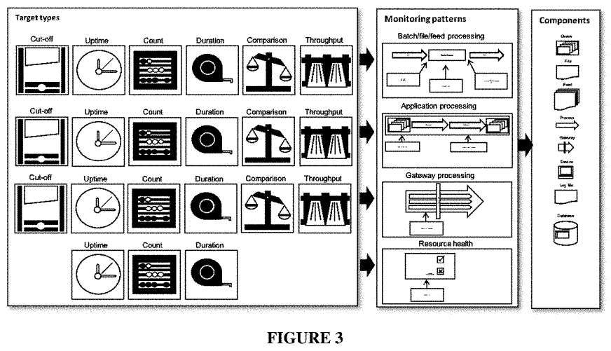

Further, an overview of the target types used to monitor the activity in the process is shown in the FIG. 3. FIG. 3 further shows monitoring patterns and components used by the target type. In one aspect, more than one target type may be used to monitor the activity of the process.

In one embodiment, each target type may have a specific target description that indicates what exactly is to be measured by the target type. The target type cut-off may indicate whether the activity has been completed by an actual time. Further, the target type uptime may indicate whether something is physically active, or available or operational. The target type count may indicate whether a number of items is less or more than or equal to a control number. The target type duration may indicate whether the time taken for a process to complete falls within a control time range. The target type throughput may indicate whether the rate of items processed, e.g. Transactions, falls within a control range. The target type comparison may indicate whether the variance between two numbers is less or more than or equal to a control metric.

Upon capturing the target data, the analysing module may analyse the target data using threshold data and data stream in real time. The data may be accessed through the search engine 110 and the data may be searched in the repository 116 In one aspect, the threshold data may be a condition that is evaluated to determine whether a given target is met and the measured metric is performing to the required level during the predefined time. Further, the data stream may be an underlying mechanism for providing an observation data into the system 100. The data stream may be referred as a base search. The system 102, also refereed as iControl, may comprise provider, schedule, translation, calculation, and the like.

In one embodiment, the analysis may comprise comparing the target data with threshold data stored in the repository 218 in view of the data stream. The threshold data may be associated with the target type. The target data may comprise the target description, the target type, a historical target status, the historical target impact and the like. The target data may be stored in a repository.

Once the target type is identified by comparing data stored in the repository 116, the activity in the process may then be monitored by the monitor module. The activity is monitored while referring to the index module 118 defining targets and observations. . The activity may be monitored using the one or more target types from the count, the cut-off, the uptime, the duration, the throughput, and the count defined by the index module 118. Further, a table may be generated based on the monitoring. The table is stored in the repository 116. The table may indicate the one or more target types and the status of each target type.

In one exemplary embodiment, table 1 as shown below may show the different target types used for monitoring the end to end activity in the process

TABLE 1
Target types

| Flow Step | Specific Action verbs (indicator words) | |
|---|---|---|
| event | Defined Target Type | |
| Determines | Arrived, Downloaded, | Cut off: Provides the ability |
| the status | Received {Capture event} | to measure is a deadline is |
| of all the | Waiting for, when, at | going to be breached. |
| discreet | {Timed event} | Examples: Payments to be |
| events | Delivered, Sent, Uploaded, | sent on time; Customer to |
| | Reported, Archived, Fulfilled | receive orders on time. |
| | Completed {Manual event} | |
| Ongoing | Available, Up, Running, | Uptime: This allows the |
| service | Exists | measurement of the |
| | Open, Connected | availability of a service |
| | | against the SLA. |
| | | Examples: How long was |
| | | this system up versus the |
| | | intended timeframe. |
| Processing | Backlog, Pending, Queued | Count: This provide the |
| activity | Greater than, less than, equal | criteria to measure a count |
| | to, {Operator} | of items. The target type |
| | Validating, Qualifying, | allows multiple thresholds |
| | Verifying, Filtering, | over different times (to deal |
| | Checking, Transforming, | with peak periods such as |
| | Converting, Calculating, | start of day). |
| | Adjusting, Creating, | Examples: How may |
| | Amending, Updating | payments are in the queue |
| | | awaiting processing. How |
| | | many orders have not been |
| | | processed? |
| | Same as, Matches, Compared | Comparison: This metric |
| | with, Variance | will provide the variance |
| | Reconciling, Consolidating | of two numbers. This is |
| | | useful for comparing |
| | | exceptions. |
| | | Example: How many orders |
| | | were rejected today vs |
| | | yesterday? How many |
| | | payments are in suspense |
| | | today? |
| | Lasts, Within, Takes {time | Duration: This measures the |
| | span} | time taken for a |
| | | service/process. |
| | | Examples: How long did it |
| | | take to process this order |
| | | from entry to exit. |
| | Rate, per, Units/Time | Throughput: This measure |
| | | the rate of items processed |
| | | within a time period and is |
| | | a useful metric for capacity |
| | | planning. |
| | | Examples: How many |
| | | orders were processed in |
| | | the last hour? |

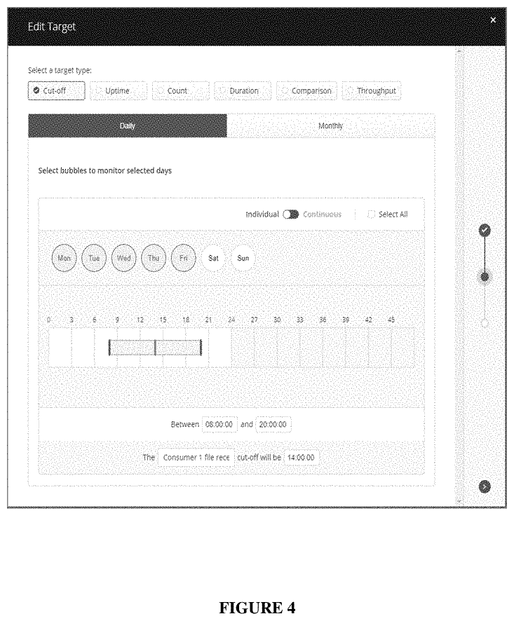

Referring now to FIG. 4, an exemplary embodiment of monitoring the activity in a process using a cut-off as a target type, is illustrated in an accordance with an embodiment of the present subject matter. In one embodiment, target data associated with the target type cut-off may be captured. The target data may be captured for a start time and an end time. Also, a time, in threshold data, at which the target should met may be stored in a repository. Further, a target impact may be displayed to a user. The target impact may be notified to the user via an alert email. In one aspect, information regarding a priority level and a region may be received from the user. In one example, the priority may be one of a priority one, a priority two and the like. In the example, a range associated with each level of the priority, such as the priority one, the priority two, and the like, may be predefined. Further, the region may be a city, a country and the like. Further, the activity may be monitored for the target type cut-off.

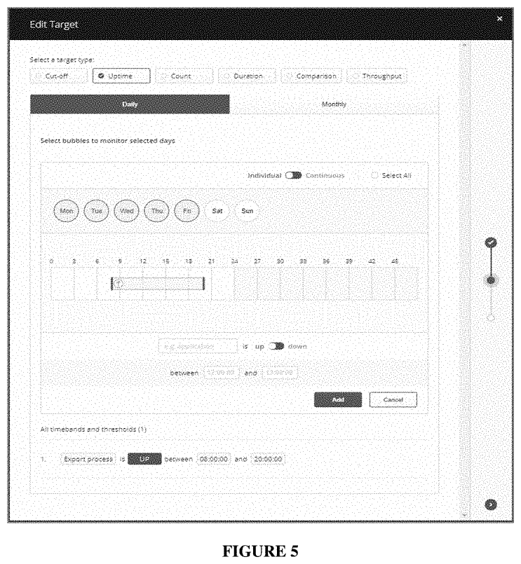

Referring now to FIG. 5, an exemplary embodiment of monitoring the activity in a process using an uptime as a target type, is illustrated in an accordance with an embodiment of the present subject matter. In one embodiment, target data associated with the target type uptime may be captured. The target data may be captured for a start time and an end time. Multiple uptimes may be defined during an active monitoring days. The active monitoring days may be referred as a predefined time for multiple days of monitoring the activity in the process. Further, the activity may be monitored for the target type uptime.

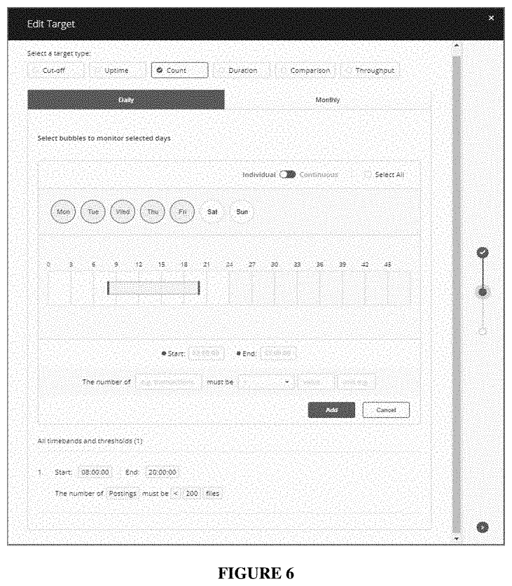

Referring now to FIG. 6, an exemplary embodiment of monitoring the activity in a process using a count as a target type, is illustrated in an accordance with an embodiment of the present subject matter. In one embodiment, target data associated with the target type count may be captured. The target data may be captured for a start time and an end time. Further, the target data associated with the target type count may comprise a count value, and an associated rule. The associated rule may correspond to greater than, equal to, and less than. In one aspect, multiple counts may be defined for the target to allow for naturally occurring fluctuations such as busy periods of the day. Further, the activity in the process may be monitored using the target type count.

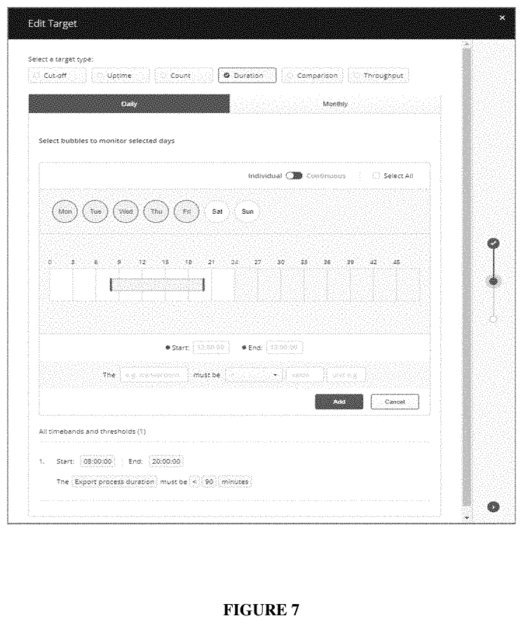

Referring now to FIG. 7, an exemplary embodiment of monitoring the activity in a process using a duration as a target type, is illustrated in an accordance with an embodiment of the present subject matter. In one embodiment, target data associated with the target type duration may be captured. The target data may be captured for a start time and an end time. Further, the target data associated with the target type duration may comprise a duration value and associated rules. The associated rules may comprise greater than, equal to, and less than. In one aspect, multiple durations may be defined for the target to allow for naturally occurring fluctuations such as busy periods of the day. Further, the activity in the process may be monitored by the target type duration.

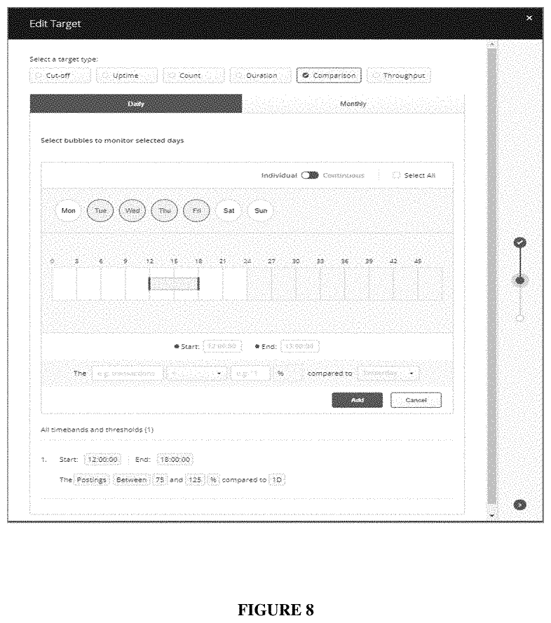

Referring now to FIG. 8, an exemplary embodiment of monitoring the activity in a process using a comparison as a target type, is illustrated in an accordance with an embodiment of the present subject matter. In one embodiment, target data associated with the target type comparison may be captured. The target data may be captured for a start time and an end time. Further, the target data associated with the target type comparison may comprise a comparison period and associated rules. The associated rules may comprise greater than, equal to, and less than. Further, the activity in the process may be monitored by the target type comparison.

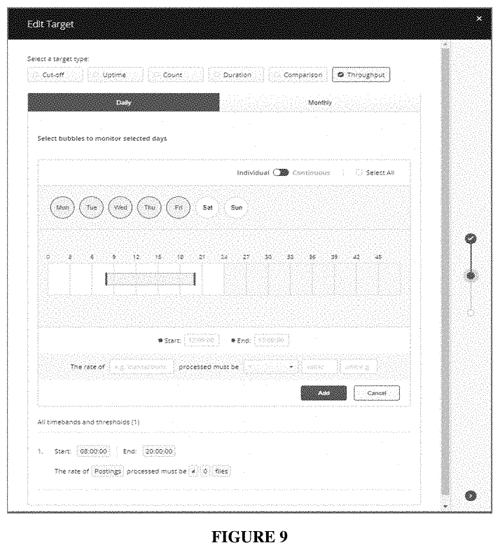

Referring now to FIG. 9, an exemplary embodiment of monitoring the activity in a process using a throughput as a target type, is illustrated in an accordance with an embodiment of the present subject matter. In one embodiment, target data associated with the target type throughput may be captured. The target data may be captured for a start time and an end time. Further, the target data associated with the target type throughput may comprise a throughput value and associated rules. The associated rules may comprise greater than, equal to, and less than. Further, the activity in the process may be monitored using the target type throughput.

In one embodiment, monitoring module may be configured to create a new target in a target list associated with the target type. The target list may comprise all the target types. Further, monitoring module may comprise generating a notification indicating the target import associated with the target type. In one aspect, the monitoring module may be configured to change the priority level, and a reporting region associated with the target type. The region and the priority level may be changed by the user based on the requirements associated with monitoring the activity in the process.

In one aspect, the monitoring module may be further configured to predict performance of each activity. The performance of the activity may be predicted based on an analysis of the monitored data of the activity for a specific target type. The prediction may help to avoid any future failure.

Exemplary embodiments discussed above may provide certain advantages. Though not required to practice aspects of the disclosure, these advantages may include those provided by the following features.

Some embodiments of the system and the method is configured to monitor end to end activities in a business process.

Some embodiments of the system and the method is configured to predict the performance of the activities in the business process to avoid future failure.

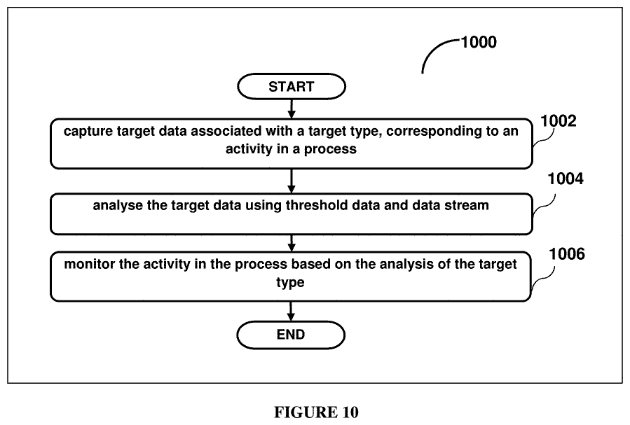

Referring now to FIG. 10, a method 1000 for monitoring an activity in a process, is disclosed in accordance with an embodiment of the present subject matter. The method 1000 may be described in the general context of computer executable instructions. Generally, computer executable instructions can include routines, programs, objects, components, data structures, procedures, modules, functions, and the like, that perform particular functions or implement particular abstract data types. The method 1000 may also be practiced in a distributed computing environment where functions are performed by remote processing devices that are linked through a communications network. In a distributed computing environment, computer executable instructions may be located in both local and remote computer storage media, including memory storage devices.

The order in which the method 1000 is described is not intended to be construed as a limitation, and any number of the described method blocks can be combined in any order to implement the method or alternate methods. Additionally, individual blocks may be deleted from the method 1000 without departing from the spirit and scope of the subject matter described herein. Furthermore, the method can be implemented in any suitable hardware, software, firmware, or combination thereof. However, for ease of explanation, in the embodiments described below, the method 1000 may be considered to be implemented in the above described system 100.

At block 1002, target data associated with a target type corresponding to an activity in a process may be captured. In one implementation, the capturing module 212 may capture the target data. The target type may be one or more of a count, an uptime, a cut-off, a duration, a comparison and a throughput.

At block 1004, the target data may be analysed using threshold data and data stream in real time. In one implementation, the analysing module 214 may analyse the target.

At block 1006, the activity in the process may be monitored based on the analysis. In one implementation, the monitoring module 216 may monitor the activity in the process.

Although implementations for systems and methods for monitoring an activity in a process have been described, it is to be understood that the appended claims are not necessarily limited to the specific features or methods described. Rather, the specific features and methods are disclosed as examples of implementations for monitoring the activity in the process.

1. A method (1000) for monitoring an activity in a process, the method (1000) comprising:
capturing, by a processor (202), target data associated with a target type, corresponding to an activity in a process, wherein the activity is selected by a user, wherein the target type comprises at least one of a cut-off, an uptime, a count, a duration, a throughput, and a comparison;
receiving, by the processor (202), each of a priority level, and a reporting region associated with the target type from the user, wherein the priority level and the reporting region are changed based on the requirements associated with monitoring the activity in the process;
analysing, by the processor (202), the target data using threshold data and data stream in real time, wherein the data is accessed through a search engine (110), and wherein the search engine (110) comprises a search app (114) for storing rules engine and backend functionality comprising each of a calculation of target performance, storing of base data, and responding to user requests; and
monitoring, by the processor (202), the end to end activity in the process based on the analysis of the target type through one or more monitoring patterns and components used by the target type, wherein the activity is monitored while referring to an index module (118) defining targets and observations as an index, and wherein the data required for monitoring is received through external databases and repository (116), and wherein performance of each activity is predicted based on an analysis of the monitored data of the activity for the target type.

2. The method as claimed in claim 1, wherein the target data comprises a target status, the target type, a target owner, a target description and a target impact.

3. The method as claimed in claim 1, wherein the target data is captured for a pre-defined time, wherein the pre-defined time is associated with a start time and an end time.

4. The method as claimed in claim 1, comprising:
creating a new target in a target list associated with the target type.

5. The method as claimed in claim 1, comprising:
generating a notification indicating the target import associated with the target type.

6. (canceled)

7. A system (102) for monitoring an activity in a process, the system (102) comprising:
a platform providing monitoring of activity;
a user interface system 102 configured to:
capture target data associated with a target type, corresponding to an activity in a process, wherein the activity is selected by a user, wherein the target type is one of a cut-off, an uptime, a count, a duration, a throughput, and a comparison;
receive each of a priority level, and a reporting region associated with the target type from the user, wherein the priority level and the reporting region are changed based on the requirements associated with monitoring the activity in the process;
analyse the target data using threshold data and data stream in real time, wherein the data is accessed through a search engine (110), and wherein the search engine (110) comprises a search app (114) for storing rules engine and backend functionality comprising each of a calculation of target performance, storing of base data, and responding to user requests; and
monitor the end to end activity in the process based on the analysis of the target type through one or more monitoring patterns and components used by the target type, wherein the activity is monitored while referring to an index module (118) defining targets and observations as an index, and wherein the data required for monitoring is received through external databases and repository (116), and wherein performance of each activity is predicted based on an analysis of the monitored data of the activity for the target type.

8. The system as claimed in claim 7, wherein the target data comprises a target status, the target type, a target owner, a target description and a target impact.

9. The system as claimed in claim 7, wherein the target data is captured for a pre-defined time comprising a start time and an end time.

10. The system as claimed in claim 7, further configured to create a new target in a target list associated with the target type.

11. The system as claimed in claim 7, further configured to generate a notification indicating the target import associated with the target type.

12. (canceled)
